(19) United States
(12) Patent Application Publication
(10) Pub. No.: US 2016/0232862 A1
(43) Pub. Date: Aug. 11, 2016

(54) DISPLAY APPARATUS

(71) Applicant: Samsung Display Co., Ltd., Yongin-City (KR)

(72) Inventors: Yu-Kwan KIM, Incheon (KR); Jai-Hyun KOH, Hwaseong-si (KR); Sungjae PARK, Wonju-si (KR)

(21) Appl. No.: 14/824,767

(22) Filed: Aug. 12, 2015

(30) Foreign Application Priority Data
Feb. 5, 2015 (KR) 10-2015-0018114

(51) Int. Cl. G09G 3/36

(52) U.S. Cl. CPC G09G 3/3614; G09G 3/3607; G09G 3/3648; G09G 3/3696; G09G 3/3685; G09G 2300/0426; G09G 2300/0452; G09G 2310/08

(57) ABSTRACT

Provided is a display apparatus. The display apparatus includes a plurality of gate lines configured to receive gate signals and extending in a first direction, a plurality of data lines configured to receive data voltages and extending in a second direction that intersects the first direction, a plurality of pixels connected to the gate lines and data lines, and a plurality of inversion lines configured to receive inversion voltages having polarities opposite to those of the data voltages and extending in the second direction.

### CROSS-REFERENCE TO RELATED APPLICATIONS

This U.S. non-provisional patent application claims priority under 35 U.S.C. §119 of Korean Patent Application No. 10-2015-0018114, filed on Feb. 05, 2015, the entire contents of which are hereby incorporated by reference.

### BACKGROUND

The present disclosure herein relates to a display apparatus, and more particularly, to a display apparatus that is capable of preventing a ripple of a common voltage from occurring.

General display apparatuses express colors by using three primary colors such as red, green, and blue colors. Thus, a display panel used for the display apparatuses includes pixels corresponding to the red, green, and blue colors.

Recently, display apparatuses displaying colors by using the red, green, blue, and main colors are being developed. The main color may be one or two or more of magenta, cyan, yellow, and white colors. Also, to improve luminance of a display image, display apparatuses including red, green, blue, and white pixels are being developed. Such a display apparatus receives red, green, and blue image signals to convert the received image signals into red, green, blue, and white data signals.

The converted red, green, blue, and white data signals may be provided to the red, green, blue, and white pixels, respectively. As a result, an image may be displayed by the red, green, blue, and white pixels.

### SUMMARY

The present disclosure provides a display apparatus that is capable of preventing a ripple of a common voltage to improve display quality.

Embodiments of the inventive concept provide display apparatuses including: a plurality of gate lines configured to receive gate signals and extending in a first direction; a plurality of data lines configured to receive data voltages and extending in a second direction that intersects the first direction; a plurality of pixels connected to the gate lines and data lines; and a plurality of inversion lines configured to receive inversion voltages having polarities opposite to those of the data voltages and extending in the second direction.

In some embodiments, each of the inversion lines may be disposed adjacent to a corresponding data line of the data lines.

In other embodiments, the display apparatuses may further include: a gate driving unit for applying the gate signals to the gate lines; and a data driving unit for applying the data voltages to the data lines.

In still other embodiments, the display apparatuses may further include an inversion driving unit for receiving the data voltages from the data lines and inverting the polarities of the data voltages to output the inverted voltages.

In even other embodiments, the inversion driving unit may be disposed to face the data driving unit with a display panel therebetween.

In yet other embodiments, the inversion driving unit may include a plurality of inversion units disposed to correspond to the inversion lines to invert the polarities of the data voltages, thereby outputting the inverted voltages.

In further embodiments, each of the data lines may have one end connected to the data driving unit, and each of the inversion units has an input terminal connected to the other end of a corresponding data line of the data lines, and each of the inversion units has an output terminal connected to a corresponding inversion line of the inversion lines.

In still further embodiments, the inversion driving unit may be disposed between the display panel and the data driving unit.

In even further embodiments, the inversion driving unit may include a plurality of inversion units configured to invert the polarities of the data voltages to output the inverted voltages, and each of the data lines has one end connected to the data driving unit, and each of the inversion units has an input terminal connected to the other end of a corresponding data line of the data lines, and each of the inversion units has an output terminal connected to a corresponding inversion of the inversion lines.

In yet further embodiments, the display apparatuses may further include: a gate driving unit configured to generate the gate signals; and a data driving unit configured to generate the data voltages to invert polarities of the data voltages, thereby outputting the inverted voltages.

In much further embodiments, the data driving unit may include an inversion driving unit for generating the inversion voltages.

In still much further embodiments, each of the pixels may represent any one of red, green, blue, white, yellow, cyan, and magenta colors.

In even much further embodiments, the pixels may be grouped into first and second pixel groups, and the first and second pixel groups are alternately disposed in the first and second directions.

In yet much further embodiments, the first and second pixel groups in a h-th (where h is a natural number) row and the first and second pixel groups in an h+1-th row may be configured to receive data voltages having polarities different from each other.

In some embodiments, each of the first and second pixel groups may include 2k (where k is a natural number) pixels.

In other embodiments, each of the first pixel groups may include two of red, green, blue, and white pixels, and each of the second pixel groups may include the other two of the red, green, blue, and white pixels.

In yet other embodiments, the polarities of the data voltages may be inverted in unit of one data line and in every frame.

In further embodiments, each of the pixels may include: a first sub pixel configured to receive a corresponding data voltage of the data voltages to charge a first pixel voltage; and a second sub pixel configured to receive a data voltage having the same polarity as that of the data voltage to charge a second pixel voltage having a level different from that of the first pixel voltage.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram of a display apparatus according to a first embodiment of the inventive concept;

FIG. 2 is an equivalent circuit diagram of one pixel of FIG. 1;

FIG. 3 is a view illustrating constitutions of a first inversion unit of FIG. 1;

FIG. 4 is a plan view illustrating a portion of a display panel of FIG. 1;

FIG. 5 is a view illustrating a portion area of a comparison display panel driven with a single color;

FIG. 6 is a block diagram of a display apparatus according to a second embodiment of the inventive concept;

FIG. 7 is a block diagram of a display apparatus according to a third embodiment of the inventive concept;

FIGS. 8, 9, 10, 11, 12, 13, 14, 15, 16, 17, 18, and 19 are plan views illustrating a portion of each of display panels according to various embodiments of the inventive concept;

FIG. 20 is a plan view illustrating a portion of the display panel according to an embodiment of the inventive concept;

FIG. 21 is an equivalent circuit diagram of one pixel of FIG. 20; and

FIG. 22 is another equivalent circuit diagram of one pixel of FIG. 20.

### DETAILED DESCRIPTION OF THE EMBODIMENTS

Since the present disclosure may have diverse modified embodiments, specific embodiments are illustrated in the drawings and are described in the detailed description of the inventive concept. However, this does not limit the present disclosure within specific embodiments and it should be understood that the present disclosure covers all the modifications, equivalents, and replacements within the idea and technical scope of the inventive concept. Like reference numerals refer to like elements throughout.

It will be understood that when an element such as a layer is referred to as being “on” another element, it can be directly on the other element or intervening elements may also be present. On the other hand, it will be understood that when an element such as a layer is referred to as being “directly on” another element, it can be directly on the other element without other intervening elements being present. The term and/or includes any and all combinations of one or more of the associated listed items.

In the description of embodiments, “below”, “beneath”, “lower”, “above”, and “upper” that are the terms of relatively expressing a space may be used to easily explain relationships between one element or constitutions and other element or constitutions. It should be understood that the terms of relatively expressing the space are terms including other directions of the element when it is used or driven in addition to a direction illustrated in the drawing. Like reference numerals refer to like elements throughout.

Also, though terms like a first and a second are used to describe various elements, components, and/or sections in various embodiments, the elements, components, and/or sections are not limited to these terms. These terms are used only to differentiate one element, component, or section from another one. Thus, a first element, a first component, or a first section described below may be a second element, a second component, or a second section in the technical inventive concept.

Additionally, the embodiment in the detailed description will be described with sectional views as ideal exemplary views of the inventive concept. Accordingly, shapes of the exemplary views may be modified according to manufacturing techniques and/or allowable errors, e.g., tolerances. Therefore, the embodiments are not limited to the specific shape illustrated in the exemplary views, but may include other shapes that may be created according to manufacturing processes. Areas exemplified in the drawings have general properties, and are used to illustrate a specific shape of a region of the element. Thus, this should not be construed as limited to the scope of the inventive concept,

Hereinafter, embodiments of the inventive concept will be described in detail with reference to the accompanying drawings.

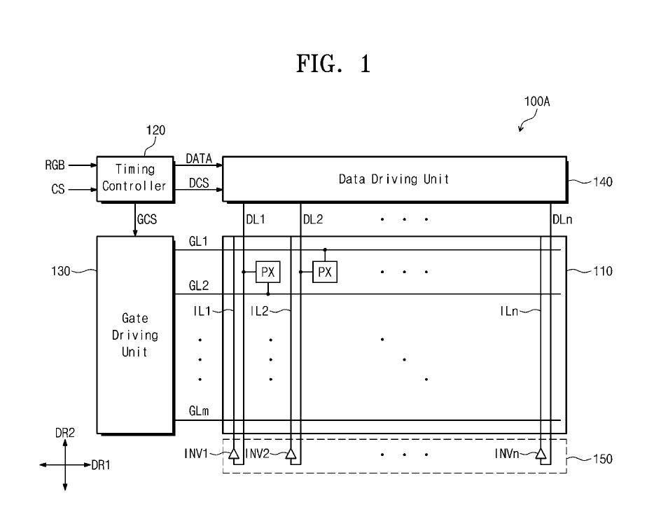

FIG. 1 is a block diagram of a display apparatus according to a first embodiment of the inventive concept.

Referring to FIG. 1, a display apparatus 100A according to a first embodiment of the inventive concept includes a display panel 110, a timing controller 120, a gate driving unit 130, a data driving unit 140, and an inversion driving unit 150.

The display panel 110 may be a liquid crystal display panel including two substrates facing each other and a liquid crystal layer disposed between the two substrates. The display panel 110 includes a plurality of gate lines GL1 to GLm, plurality of data lines DL1 to DLn, a plurality of inversion lines IL1 to ILn, and a plurality of pixels PX. Here, reference symbols m and n are natural numbers.

The gate lines GL1 to GLm may extend in a first direction DR1 and thus be connected to the gate driving unit 130. The data lines DL1 to DLn extend in a second direction DR2 that intersects the first direction DR1. Each of the data lines DL1 to DLn has one end that is connected to the data driving unit 140. The other end of each of the data lines DL1 to DLn is connected to the inversion driving unit 150.

The inversion lines IL1 to ILn may extend in the second direction DR2 and thus be connected to the inversion driving unit 150. The number of the inversion lines IL1 to ILn may be the same as that of the data lines DL1 to DLn. Each of the inversion lines IL1 to ILn is disposed adjacent to a corresponding data line of the data lines DL1 to DLn. That is, the inversion lines IL1 to ILn are disposed to correspond to the data lines DL1 to DLn one by one.

The pixels PX are disposed on areas partitioned by the gate lines GL1 to GLm and the data lines DL1 to DLn that cross each other. Thus, the pixels PX may be arranged in a matrix form.

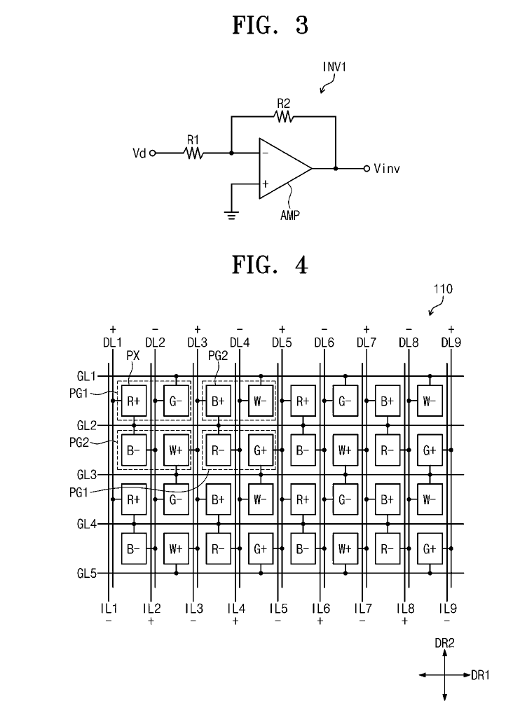

The pixels PX are connected to the gate lines GL1 to GLm and the data lines DL1 to DLn. Hereinafter, connections between the pixels PX and the gate lines GL1 to GLm and the data lines DL1 to DLn will be described in detail with reference to FIG. 3.

Each of the pixels PX may display one of the primary colors. The primary colors may include red, green, blue, and white colors.

However, the present disclosure is not limited thereto, and the primary colors may further include various colors such as yellow, cyan, and magenta colors.

The timing controller 120 may be mounted on a printed circuit board in an integrated circuit chip form and thus be connected to the gate driving unit 130 and the data driving unit 140. The timing controller 120 receives image signals RGB and a control signal CS from the outside (for example, a system board).

The control signal CS may include a vertical synchronization signal that is a frame distinction signal, a horizontal synchronization signal that is a row distinction signal, a data enable signal that has a high level only while data is outputted in order to display a section into which the data is inputted, and a main clock signal.

The timing controller 120 may convert a data format of the image signals RGB to match an interface specification with the data driving unit 140. The timing controller 120 provides the image data DATA in which the data format is converted to the data driving unit 140.

The timing controller 120 generates a gate control signal GCS and a data control signal DCS in response to the control signal CS. The gate control signal GCS is a control signal for controlling an operation timing of the gate driving unit 130. The data control signal DCS is a control signal for controlling an operation timing of the data driving unit 140.

The gate control signal GCS may include a scan start signal that instructs a start of scanning, at least one clock signal for controlling an output period of a gate-on voltage, and an output enable signal that restricts a duration time of the gate-on voltage.

The data control signal DCS may include a horizontal start signal notifying a start in which the image data DATA is transmitted to the data driving unit 140, a load signal that is a command signal for applying a data voltage to the data lines DL1 to DLn, and a polarity control signal determining a polarity of the data voltage with respect to the common voltage.

The timing controller 120 provides the gate control signal GCS to the gate driving unit 130 and provides the data signal DCS to the data driving unit 140.

The gate driving unit 130 generates gate signals in response to the gate control signal GCS. The gate signals may be successively output. The gate signals are provided to the pixels PX in a row unit, through the gate lines GL1 to GLm.

The data driving unit 140 may generate analog type data voltages corresponding to the image data DATA in response to the data control signal DCS. The data voltages are provided to the pixels PX through the data lines DL1 to DLn.

Each of the gate driving unit 130 and the data driving unit 140 may be provided with a plurality of driving chips and mounted on a flexible PCB. Also, the gate driving unit 130 and the data driving unit 140 nay be connected to the display panel 110 in a tape carrier package (TCP) manner.

However, the present disclosure is not limited thereto, each of the gate driving unit 130 and the data driving unit 140 may be provided with the plurality of driving chips and thus be mounted on the display panel 110 in a chip on glass (COG) manner. Also, the gate driving unit 130 may be simultaneously provided together with transistors of the pixels PX and thus be mounted on the display panel 110 in an amorphous silicon TFT gate driver circuit (ASG) manner.

The polarity of the data voltage applied to each of the pixel PX may be inverted for every frame to prevent liquid crystal molecules of the liquid crystal layer from being degraded. For example, the data driving unit 140 may invert and output the polarity of the data voltages for every frame in response to the polarity control signal.

Also, when an image of one frame is displayed, data voltages hiving polarities different from each other may be outputted in one data line unit to improve quality and thus be provided to the pixels PX.

The pixels PX receive the data voltages through the data lines DL1 to DLn in response to the gate signals received through the gate lines GL1 to GLm. The pixels PX may display a gray scale corresponding to the data voltages to display the image.

The inversion driving unit 150 may be disposed to face the data driving unit 140 with the display panel 110 therebetween. The inversion driving unit 150 connects the data lines DL1 to DLn to the inversion lines IL1 to ILn. The inversion driving unit 150 may invert the polarities of the data voltages received through the data lines DL1 to DLn to apply the data voltages to the inversion lines IL1 to ILn.

The inversion driving unit 150 includes a plurality of inversion units INV1 to INVn disposed to correspond to the inversion lines IL1 to ILn. Each of the data lines DL1 to DLn has the other end that is connected to an input terminal of the corresponding inversion unit of the inversion units INV1 to INVn.

Each of the inversion lines IL1 to ILn is connected to an output terminal of the corresponding inversion unit of the inversion units INV1 to INVn. That is, each of the data lines DL1 to DLn is connected to the corresponding inversion line of the inversion lines DL1 to DLn by the inversion units INV1 to INVn.

The inversion units INV1 to INVn may invert the polarities of the data voltages received through the data lines DL1 to DLn to output the inverted data voltages through the inversion lines IL1 to ILn. Hereinafter, voltages having polarities opposite to those of the data voltages and applied to the inversion lines IL1 to ILn may be called inversion voltages. Since the inversion voltages have polarities opposite to those of the data voltages, the sum of the polarities of the data voltages and the polarities of the inversion voltages may be offset by the inversion voltages.

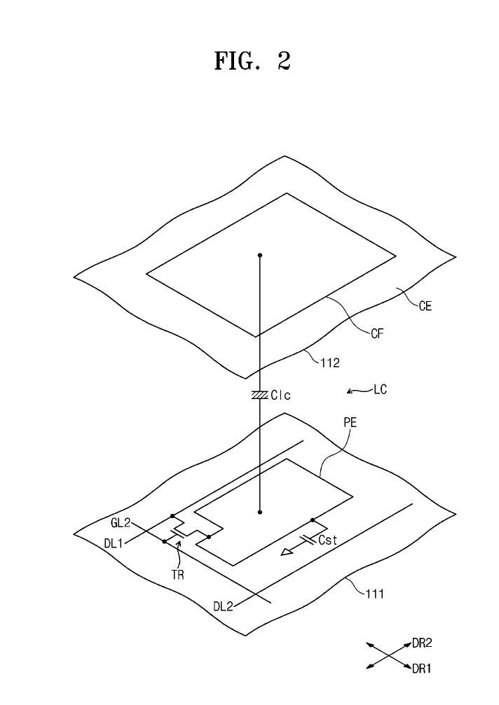

FIG. 2 is an equivalent circuit diagram of one pixel of FIG. 1.

For convenience of description, the pixel PX connected to the second gate line GL2 and the first data line DL1 is illustrated in FIG. 2. Although not shown, configurations of the other pixels PX of the display panel 110 may be substantially the same as those of the pixel PX illustrated in FIG. 2.

Referring to FIG. 2, the display panel 110 includes a first substrate 111, a second substrate 112 facing the first substrate 111, and a liquid crystal layer LC disposed between the first and second substrates 111 and 112.

The pixel PX includes a transistor TR connected to the second gate line GL2 and the first data line DL1, a liquid crystal capacitor Clc connected to the transistor TR, and a storage capacitor Cst parallelly connected to the liquid crystal capacitor Clc. The storage capacitor Cst may be omitted.

The transistor TR may be disposed on the first substrate 111. The transistor TR includes a gate electrode connected to the second gate line GL2, a source electrode connected to the first data line DL1, and a drain electrode connected to the liquid crystal capacitor Clc and the storage capacitor Cst.

The liquid crystal capacitor Clc includes a pixel electrode PE disposed on the first substrate 111, a common electrode CE disposed on the second substrate 112, and the liquid crystal layer LC disposed between the pixel electrode PE and the common electrode CE. The liquid crystal layer LC acts as a dielectric. The pixel electrode PE is connected to the drain electrode of the transistor TR.

In FIG. 2, although the pixel electrode PE has a non-slit structure, the present disclosure is not limited thereto. For example, the pixel electrode PE may have a slit structure including a stem part having a cross shape and a plurality of branch parts radially extending from the stem part.

The common electrode CE may be disposed on a whole second substrate 112. However, the present disclosure is not limited thereto, and the common electrode CE may be disposed on the first substrate 111. In this case, at least one of the pixel electrode PE and the common electrode CE may include a slit.

The storage capacitor Cst may include a storage electrode (not shown) branched from a storage line (not shown) and an insulation layer disposed between the pixel electrode PE and the storage electrode. The storage line may be disposed on the first substrate 111 and simultaneously disposed on the same layer as the gate lines GL1 to GLm. The storage electrode may partially overlap the pixel electrode PE.

The pixel PX may further include a color filter CF representing one of the primary colors. As an exemplary embodiment, the color filter CF may he disposed on the second substrate 112 as illustrated in FIG. 2. However, the present disclosure is not limited thereto, and the color filter CF may be disposed on the first substrate 111.

The transistor TR may be turned on in response to the gate signal received through the second gate line GL2. The data voltage received through the first data line DL1 is provided to the pixel electrode PE of the liquid crystal capacitor Clc through the turned-on transistor TR The common voltage is applied to the common electrode CE.

Electric fields are formed between the pixel electrode PE and the common electrode CE by a difference of voltage levels of the data voltage and the common voltage. Liquid crystal molecules of the liquid crystal layer LC are driven by the electric fields formed between the pixel electrode PE and the common electrode CE. Light transmittivity may be adjusted by the liquid crystal molecules driven by the electric fields, and thus the image may be displayed.

Although not shown, a backlight unit for providing light to the display panel 110 may be disposed at a rear side of the display panel 110.

A storage voltage having a predetermined voltage level may be applied to the storage line. However, the present disclosure is not limited thereto, the common voltage may be applied to the storage line. The storage capacitor Cst may complement the voltage charged in the liquid crystal capacitor Clc.

FIG. 3 is a view illustrating constitutions of a first inversion unit INV1 of FIG. 1.

Although constitutions of the first inversion unit INV1 are illustrated in FIG. 3, other inversion units illustrated in FIG. 1 may substantially have the same constitutions as those of the first inversion unit INV1 of FIG. 3.

Referring to FIG. 3, the first inversion unit INV1 includes an operational amplifier AMP, a first resistor R1, and a second resistor R2. The operational amplifier AMP includes a positive (+) input terminal, a negative (−) input terminal, and an output terminal.

The positive (+) input terminal of the operational amplifier AMP is connected to the ground terminal. The first resistor R1 is connected to the negative (−) input terminal of the operational amplifier AMP. The second resistor R2 is connected to the negative (−) input terminal of the operational amplifier AMP and the output terminal of the operational amplifier AMP.

The negative (−) input terminal of the operational amplifier AMP receives a data voltage Vd through the first resistor R1. The data voltage Vd may be a data voltage that is applied to the first data line DL1. The output terminal of the operational amplifier AMP may output an inversion voltage Vinv having a polarity opposite to that of the data voltage Vd. A circuit configuration illustrated in FIG. 3 may be called an inversion amplifier. The inversion amplifier may invert and amplify the polarity of the inputted signal to output the inverted and amplified signal.

In detail, input current of the positive (+) input terminal and the negative (−) input terminal of the operational amplifier AMP is zero. The positive (+) input terminal of the operational amplifier AMP has the same voltage as the negative (−) input terminal of the operational amplifier AMP. Thus, current flowing through the first resistor R1 is the same as that flowing through the second resistor R2.

A current relationship between the first resistor R1 and the second resistor R2 at a contact point will be expressed by following mathematical formula 1 according to a Kirchhoff's Current Law (KCL) equation.

(Vd/R1)+(Vinv/R2)=0 [Mathematical formula 1]

The mathematical formula 1 may be expressed by following mathematical formula 2 as an equation with respect to a gain G.

G=(Vinv/Vd)=−(R2/R1) [Mathematical formula 2]

The current flowing in the input terminal of the operational amplifier AMP may be zero in an ideal case. However, although it substantially depends on a device, since extremely small amount of current flows in the input terminal, the current flowing in the input terminal of the operational amplifier AMP may not be completely zero. Thus, the gain G may be an approximate value having an error according to an intensity of the current flowing in the terminal.

Since the gain G is the approximate value, the inversion voltage Vinv in mathematical formula 2 may be expressed by mathematical formula 3 as follows.

(Vinv)≈−(R2/R1)Vd [Mathematical formula 3]

Thus, the first inversion unit INV1 may receive the data voltage Vd and invert the polarity of the data voltage Vd to output the inversion voltage Vinv having the polarity opposite to that of the data voltage Vd.

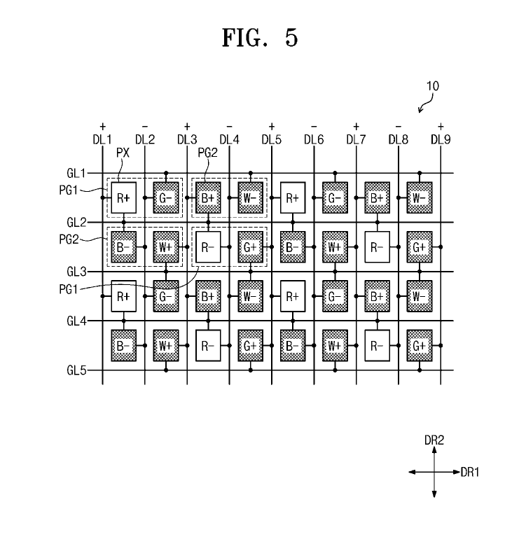

FIG. 4 is a plan view illustrating a portion of a display panel of FIG. 1. FIG. 5 is a view illustrating a portion area of a comparison display panel driven with a single color.

As an exemplary embodiment, pixels PX connected to first to fifth gate lines GL1 to GL5, first to ninth data lines DL1 to DL9, and first to ninth inversion lines IL1 to IL9 are illustrated in FIG. 4.

In FIG. 4, a red pixel is represented as reference symbol R, a green pixel is represented as reference symbol G, a blue pixel is represented as reference symbol B, and a white pixel is represented as reference symbol W for convenience of description.

In FIG. 4, the pixels PX receiving the positive (+) data voltages during a present frame are represented as reference symbols R+, G+, B+, and W+. Also, the pixels PX receiving the negative (−) data voltages during the present frame are represented as reference symbols R−, G−, B−, and W−.

Referring to FIG. 4, the pixels PX include a plurality of red pixels R representing a red color, a plurality of green pixels G representing a green color, a plurality of blue pixels B representing a blue color, and a plurality of white pixels W representing white color. However, the present disclosure is not limited thereto, and the pixels PX may further include yellow pixels, cyan pixels, and magenta pixels respectively representing yellow, cyan, and magenta colors.

The pixels PX may be grouped into first pixel groups PG1 and second pixel groups PG2. The first pixel groups PG1 and the second pixel groups PG2 may be alternately disposed in the first and second directions DR1 and DR2. However, the arrangements of the first and second pixel groups PG1 and PG2 may not be limited to those illustrated in FIG. 4, but be variously changed.

For example, the pixel groups may be disposed in the same row, and the first pixel group PG1 and the second pixel group PG2 may be alternately disposed in the second direction DR2. Also, the same pixel groups may be disposed in the same column, and the first pixel group PG1 and the second pixel group PG2 may be alternately disposed in the first direction DR1.

Each of the first and second pixel groups PG1 and PG2 may include 2k pixels PX. Here, reference symbol k is a natural number. That is, each of the first and second pixel groups PG1 and PG2 includes an even number of pixels PX. In an exemplary embodiment, the reference symbol k may be number 1. In this case, as illustrated in FIG. 4, each of the first and second pixel groups PG1 and PG2 may include two pixels PX.

Each of the first pixel groups PG1 may include two of the red, green, blue, and white pixels R, G, B, and W. Also, each of the second pixel groups PG2 may include the other two of the red, green, blue, and white pixels R, G, B, and W. That is, the first and second pixel groups PG1 and PG2 may represent colors different from each other.

For example, as illustrated in FIG. 4, each of the first pixel groups PG1 may include the red and green pixels R and G. Each of the second pixel groups PG2 may include the blue and white pixels B and W. However, the arrangements of the pixels PX may not be limited to those illustrated in FIG. 4, but be variously changed.

For example, each of the first pixel groups PG1 may include the red and blue pixels R and B, and each of the second pixel groups PG2 may include the green and white pixels G and W. Also, each of the first pixel groups PG1 may include the red and white pixels R and W, and each of the second pixel groups PG2 may include the green and blue pixels G and B.

The pixels in a c-th column disposed between a j-th data line and a j+1-th data line of the data lines DL1 to DL9 may be alternately connected to the j-th data line and the j+1-th data line in at least one pixel PX unit. The reference symbols j and c are natural numbers. Hereinafter, connections between the pixels and the data lines in a case in which each of the reference symbols j and c are number 1 will be exemplary described.

The pixels PX in a first column disposed between the first and second data lines DL1 and DL2 may be alternately connected to the first and second data lines DL1 and DL2 in one pixel unit. That is, the pixels PX disposed in each of the lines may be alternately connected to the data lines adjacent to left and right sides of the line in one pixel PX unit.

For example, in the first column, the red pixels R+ of the first pixel group PG1 may be connected to the first data line DL1, and the blue pixels B− of the second pixel group PG2 may be connected to the second data line DL2.

Two pixels PX of pixels PX in a 2c-1-th column, which are adjacent to each other in the second direction DR2 with a 2-th gate line of therebetween, may be connected to each other to share the 2i-th gate line. Here, reference symbol i is a natural number. Also, two pixels PX of pixels PX in a 2c-th column, which are adjacent to each other in the second direction DR2 with a 2i-1-th gate line therebetween, may be connected to each other to share the 2i-1-th gate line.

In detail, the red pixel R+ and the blue pixel B− of the pixels PX in the first column, which are adjacent to each other in the second direction with the second gate line GL2 therebetween, may be connected to each other to share the second gate line GL2. Also, the blue pixel B+ and the red pixel R− of the pixels PX in a third column, which are adjacent to each other in the second direction DR2 with the second gate line GL2 therebetween, may be connected to each other to share the second gate line GL2.

Thus, the red and blue pixels R+ and B− in the first column connected to the second gate line GL2 may be simultaneously driven by the gate signal received through the second gate line GL2. Also, the blue and red pixels B+ and R− in the third column connected to the second gate line GL2 may be simultaneously driven by the gate signal received through the second gate line GL2.

The white pixel W+ and the green pixel G− of the pixels PX in a second column, which are adjacent to each other in the second direction DR2 with the third gate line GL3 the between, may be connected to each other to share the third gate line GL3. The green and white pixels G+ and W− of the pixels PX in a fourth column, which are adjacent to each other in the second direction DR2 with the third gate line GL3 therebetween, may be connected to each other to share the third gate line GL3.

Thus, the white and green pixels W+ and G− the second column connected to the third gate line GL3 may be simultaneously driven by the gate signal received through the third gate line GL3. Also, the green and white pixels G+ and W− in the fourth column connected to the third gate line GL3 may be driven by the gate signal received through the third gate line GL3.

The connections of the pixels PX and the gate lines will not be limited to the foregoing configurations. For example, the two pixels PX of the pixels PX in the 2c-1-th column, which are adjacent to each other in the second direction DR2 with the 2i-1-th gate line therebetween, may be connected to each other o share the 2i-1-th gate line. Also, the two pixels PX of the pixels PX in the 2c-th column, which are adjacent to each other in the second direction DR2 with the 2i-th gate line therebetween, may be connected to each other share the 2i-th gate line.

The polarities of the data voltages applied to the data lines D1 to D9 may be inverted in one data line unit. For example, as illustrated in FIG. 4, the positive (+) data voltages may be applied to odd-numbered data lines DL1, DL3, DL5, DL7, and DL9. Also, the negative (−) data voltages may be applied to even-numbered data lines DL2, DL4, DL6, and DL8.

Thus, as illustrated in FIG. 4, the first and second pixel groups PG1 and PG2 in an h-th row and the first and second pixel groups PG1 and PG2 in an h+1-th row receive the data voltages having polarities different from each other. Here, reference symbol h is a natural number.

For example, when the reference symbol h is 1, the red pixel R+ of the first pixel group PG1 in a first row may receive the positive (+) data voltage, and the green pixel G− of the first pixel group PG1 in the first row may receive the negative (−) data voltage. Also, the red pixel R− of the first pixel group PG1 in a second row may receive the negative (−) data voltage, and the green pixel G+ of the first pixel group PG1 in the second row may receive the positive (+) data voltage.

Also, the blue pixel B+ of the second pixel group PG2 in the first row may receive the positive (+) data voltage, and the white pixel W− of the second pixel group PG2 in the first row may receive the negative (−) data voltage. Also, the blue pixel B− of the second pixel group PG2 the second row may receive the negative (−) data voltage, and the white pixel W+ of the second pixel group PG2 in the second row may receive the positive (+) data voltage.

The polarities of the data voltages provided to the pixels PX of the display panel 110 illustrated in FIG. 4 is the polarities of the present frame. As described above, the data driving unit 140 inverts the polarities of the data voltages every frame to output the inverted data voltages. Thus, the polarities of the data voltages provided to the pixels PX in the next frame may be inverted.

The inversion lines IL1 to IL9 may be disposed to correspond to the data lines DL1 to DL9 one by one. Each of the inversion lines IL1 to IL9 is disposed adjacent to the corresponding data line of the data lines DL1 to DLn. Each of the inversion lines IL1 to IL9 may receive an inversion voltage having a polarity opposite to that of the data voltage applied to the corresponding data line. As described above, the inversion lines IL1 to IL9 may receive the inversion voltages through the inversion driving unit 150.

Referring to FIG. 5, a comparison display panel 10 does not include the inversion lures IL1 to ILn and the inversion driving unit 150. The comparison display panel 10 may substantially have the same constitutions as those of the display panel 110 of FIG. 4 except that the comparison display panel 10 does not include the inversion lines IL1 to ILn and the inversion driving unit 150.

The comparison display panel 10 may be driven with a single color. For example, as illustrated in FIG. 5, red pixels R may be driven. The data voltages applied to the pixels disposed in the same row to represent the same color (hereinafter, referred to as a “same pixel”) may have the same polarity.

That is, the red pixels R in the same row may receive the data voltages having the same polarity as each other and thus be driven. For example, the red pixels R+ disposed in the first row and connected to the first and fifth data lines DL1 and DL5 may receive the positive (+) data voltage. Also, the red pixels R− disposed in the second row and connected to the fourth and eighth data lines DL4 and DL8 may receive the negative (−) data voltage.

When the data voltages applied to the red pixels R disposed in the same row has the same polarity as each other, a ripple may occur in the common voltage by a coupling phenomenon between the data lines and the common electrode. When the data voltages have a positive (+) polarity, the ripple may occur in the common voltage in a positive direction. When the data voltages have a negative (−) polarity, the ripple may occur in the common voltage in a negative direction.

Due to the ripple of the common voltage, a horizontal crosstalk phenomenon in which a luminance difference is generated in a row unit may occur. Display quality may be deteriorated by the horizontal crosstalk phenomenon. Although it is exemplary described that the horizontal crosstalk phenomenon occurs when the red pixels R is driven, the horizontal crosstalk phenomenon may occur when other pixels are driven.

Referring again to FIG. 4, in the current embodiment of the inventive concept, the inversion voltages are applied to the inversion lines IL1 to 1L9 disposed adjacent to the data lines DL1 to DL9. As described above, the inversion voltages may have polarities opposite to those of the data voltages applied to the data lines DL1 to DL9.

Thus, the sum of the polarities of the data voltages applied to the data lines DL1 to DL9 and the polarities of the inversion voltages applied to the inversion lines IL1 to IL9 may be offset, and thus the ripple of the common voltage may be prevented.

As a result, the display apparatus 100A according to an embodiment of the inventive concept may prevent the ripple of the common voltage from occurring to improve the display quality.

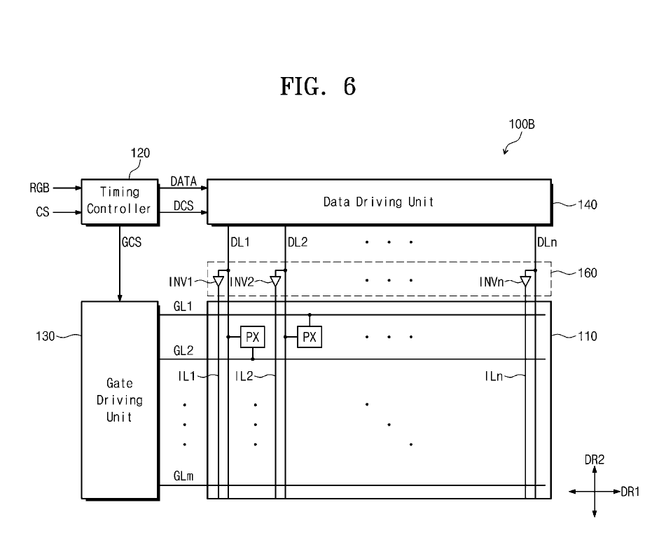

FIG. 6 is a block diagram of a display apparatus according to a second embodiment of the inventive concept.

A display apparatus 100B of FIG. 6 may substantially have the same constitutions as those of the display apparatus 100A of FIG. 1 except for arrangement of an inversion unit 160. Thus, like reference numerals in the drawings denote like elements, and hereinafter, constitutions different from those of the display device 100A of FIG. 1 will be described.

Referring to FIG. 6, the inversion driving unit 160 according to a second embodiment of the inventive concept may be disposed between the display panel 110 and the data driving unit 140. The inversion lines IL1 to ILn may extend in the second direction DR2 and be connected to the inversion driving unit 160. Each of the inversion lines IL1 to ILn is disposed adjacent to the corresponding data line of the data lines DL1 to DLn.

The inversion driving unit 160 includes a plurality of inversion units INV1 to INVn disposed to correspond to the inversion lines IL1 to ILn. Each of the data lines DL1 to DLn has one end that is connected to the data driving unit 140. Each of the inversion units INV1 to INVn has an input terminal that is connected to the one end of the corresponding data line of the data lines DL1 to DLn. Each of the inversion units INV1 to INVn has an output terminal is connected to the corresponding inversion line of the inversion lines IL1 to ILn.

The inversion units INV1 to INVn may invert the polarities of the data voltages received through the data lines DL1 to DLn. The inversion units INV1 to INVn may apply the inversion voltages in which the polarities of the data voltages are inverted to the inversion lines IL1 to ILn.

Thus, the sum of the polarities of the data voltages applied to the data lines DL1 to DLn and the polarities of the inversion voltages applied to the inversion lines ILI to ILn tray be offset, and thus the ripple of the common voltage may be prevented.

As a result, the display apparatus 100B according to a second embodiment of the inventive concept may prevent the ripple of the common voltage from occurring to improve the display quality.

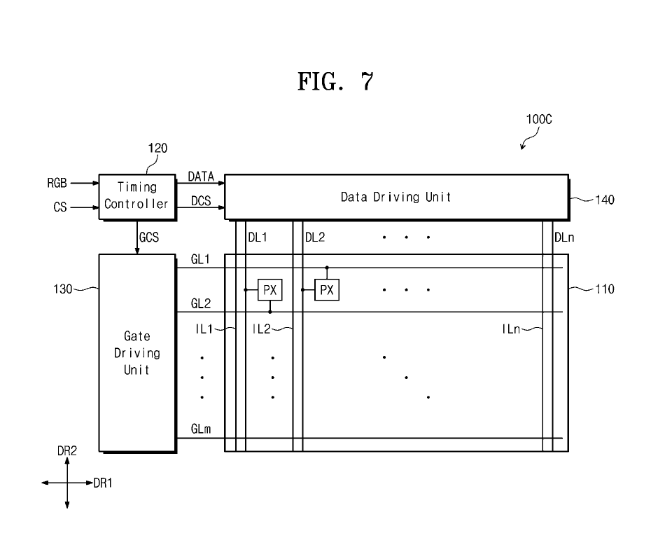

FIG. 7 is a block diagram of a display apparatus according to a third embodiment of the inventive concept.

Referring to FIG. 7, the data lines DL1 to DLn and the inversion lines IL1 to ILn may extend in the second direction DR2 and thus be connected to the data driving unit 140. Each of the inversion lines IL1 to ILn is disposed adjacent to the corresponding data line of the data lines DL1 to DLn.

The data driving unit 140 may generate the data voltages and the inversion voltages. For example, the data driving unit 140 may generate the data voltage and invert the polarities of the data1 voltages to generate the inversion voltages.

The data driving unit 140 may include the inversion driving unit for generating the inversion voltage. That is, the inversion driving unit 150 of FIG. 1 or the inversion driving unit 160 of FIG. 6 may be disposed in the data driving unit 140 to invert the polarities of the data voltages, thereby generating the inversion voltages. The data lines DL1 to DLn may receive the data voltages to provide the data voltages to the pixels PX. The inversion lines IL1 to ILn may receive the inversion voltages.

Thus, the sum of the polarities of the data voltages applied to the data lines DL1 to DLn and the polarities of the inversion voltages applied to the inversion lines IL1 to ILn may be offset, and thus the ripple of the common voltage may be prevented.

As a result, the display apparatus 100C according to a third embodiment of the inventive concept may prevent the ripple of the common voltage from occurring to improve the display quality.

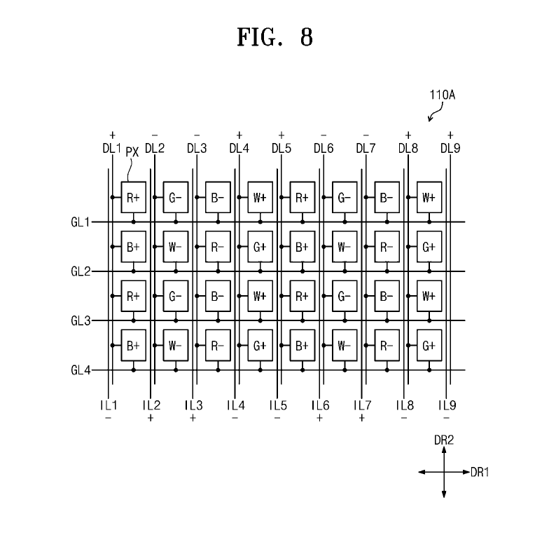

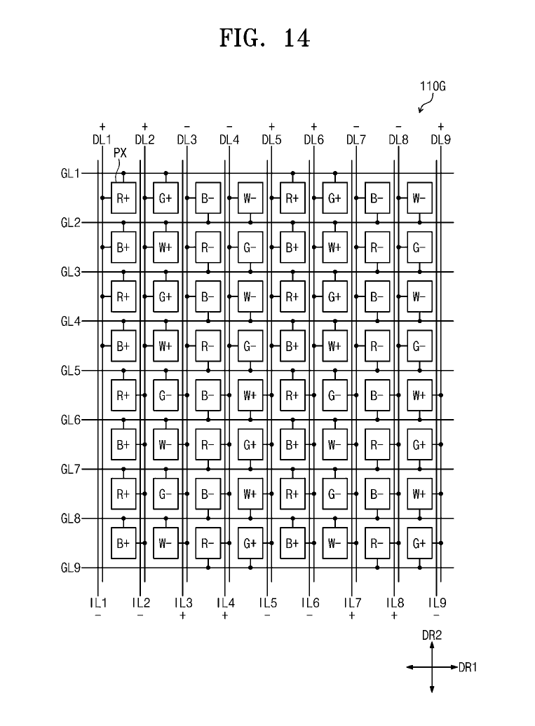

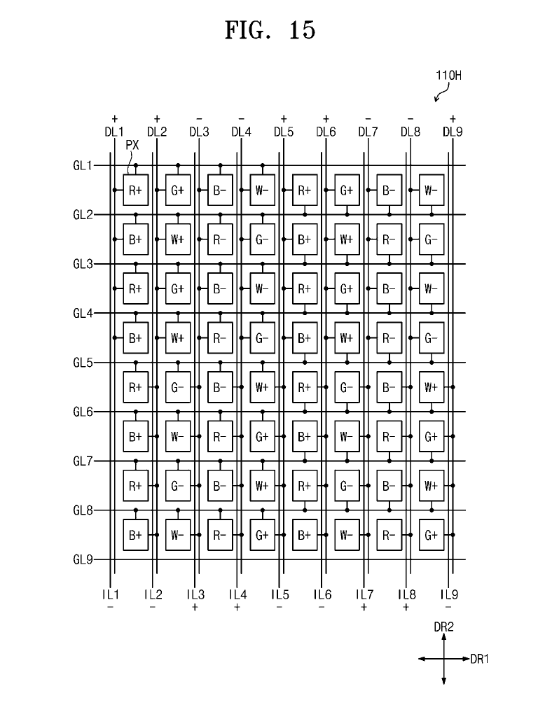

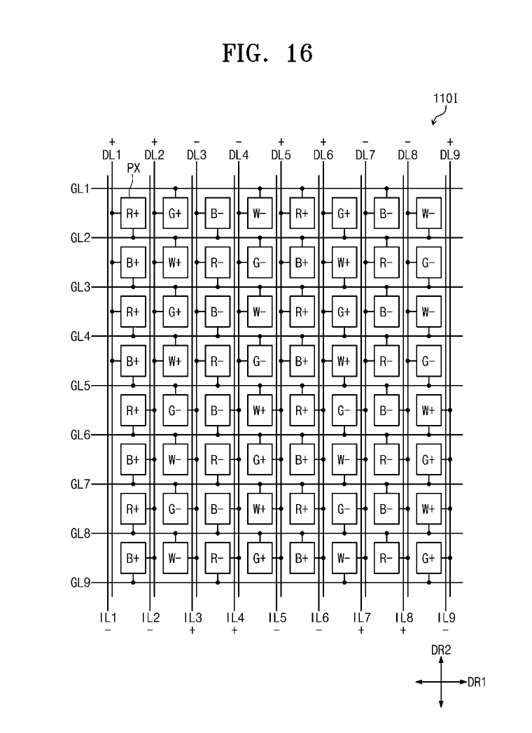

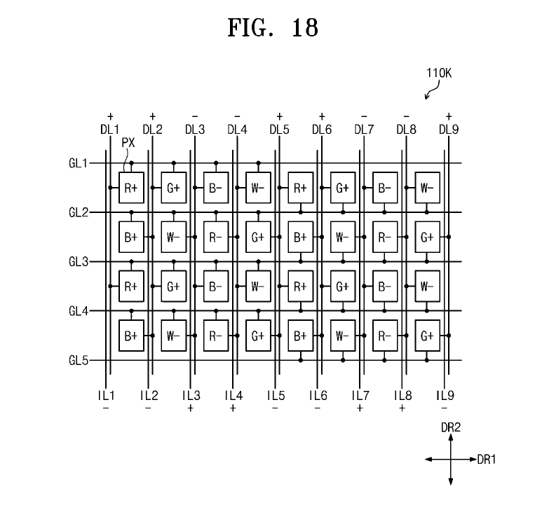

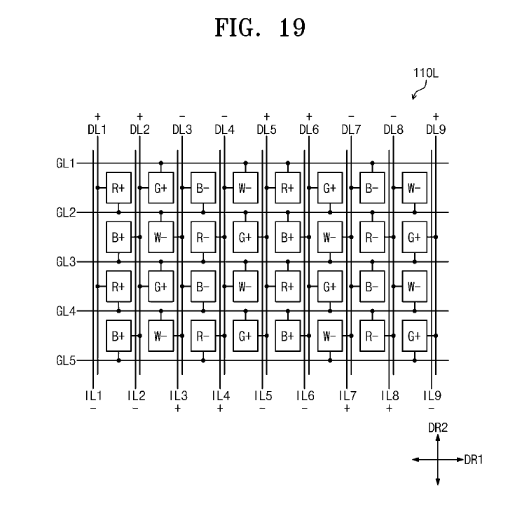

FIGS. 8 to 19 are plan views illustrating a portion of each of display panels according to various embodiments of the inventive concept.

Display panels 110A to 110L illustrated in FIGS. 8 to 19 may be used as the display panels of the display apparatuses 100A, 100B, and 100C of FIGS. 1, 6, and 7.

Hereinafter, constitutions of the display panel according to various embodiments of the inventive concept will be described with reference to FIGS. 8 to 19. Differences between the display panel according to various embodiments of FIGS. 8 to 19 and the display panel of FIG. 4 will be described, and other constitutions not described herein will follow the descriptions regarding FIG. 4.

Referring to FIG. 8, the display panel 110A includes a plurality of pixels PX. The pixels PX in the odd-numbered row are disposed in order of red pixel R, the green pixel G, the blue pixel B, and the white pixel W. The pixels PX in the even-numbered row are disposed in order of the blue pixel B, the white pixel W, the red pixel R, and the green pixel G.

The pixels PX disposed in the same row are connected to the corresponding gate line of the gate lines GL1 to GL4. The pixels PX disposed in the same column are connected to the corresponding data line of the data lines DL1 to DL8. Thus each of the pixels PX is connected to the gate line at a lower side and the data line at a left side.

The data voltages applied to the data lines DL1 to DL8 may have positive/negative/negative/positive/positive/negative/negative/positive (+−++−+) polarities. That is, positive, negative, negative, and positive data voltages may be applied to the data lines in a unit of the four data lines.

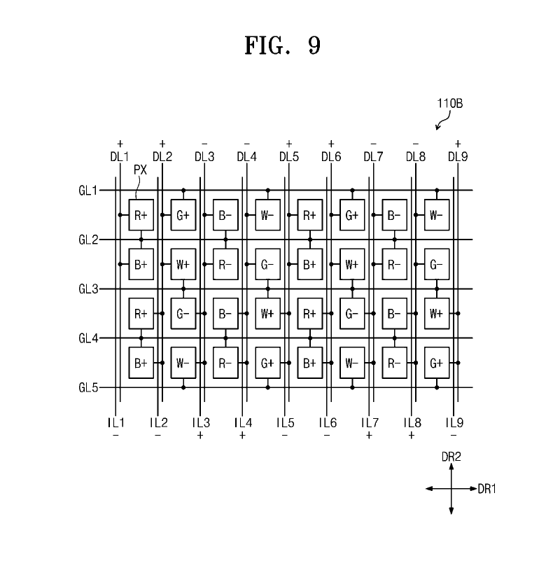

In the following embodiments, the polarities of the data voltages applied to the data lines may be inverted in a unit of the two data lines. Thus, for example, polarities of the data voltages applied to the data lines are an order of positive/positive/negative/negative/positive/positive/negative/negative (++−−++−−) polarities in FIGS. 9 to 19. That is, the polarities of the data voltages may be inverted in a unit of the two data lines.

Referring to FIG. 9, connections of the pixels PX and the gate lines GL1 to GL5 are substantially the same as those of FIG. 4. The pixels in a c-th column disposed between a j-th data line and a j+1-th data line of the display panel 110B may be alternately connected to the j-th data line and the j+1-th data line in two pixels PX unit.

When the reference symbols j and c are 1, the pixels in a first column disposed between the first and second data lines DL1 and DL2 may be alternately connected to the first and second data lines DL1 and DL2 in a unit of the two pixels. For example, the red pixel R+ in the first row of the pixels PX in the first column and the blue pixel B+ in the second row of the pixels PX in the first column may be connected to the first data line DL1. Also, the red pixel R+ in the third row of the pixels PX in the first column and the blue pixel B+ the fourth row of the pixels PX in the first column may be connected to the second data line DL2.

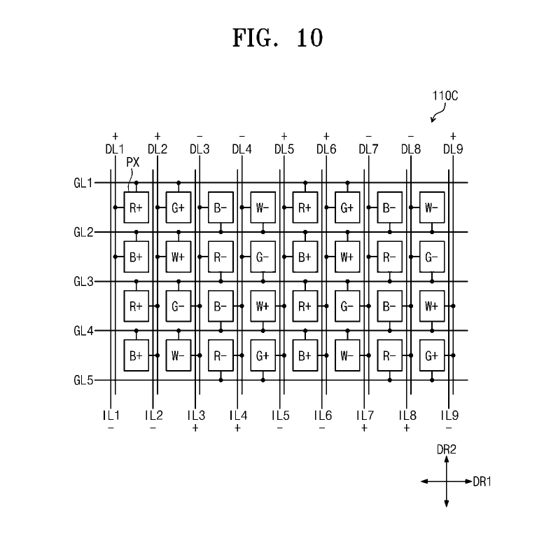

Referring to FIG. 10, connections of the pixels PX and the data lines DL1 to DL9 are substantially the same as those of FIG. 8. Pixels PX in an h-th column disposed between an i-th gate line and an i+1-th gate line of the display panel 110B may be alternately connected to the i-th gate line and the i+1-th gate line in two pixels PX unit.

When the reference symbols i and h are 1, the red and green pixels R+ and G+ of the pixels PX in the first row may be connected to the first gate line GL1, and the blue and white pixels B− and W− of the pixels PX in the first row may be connected to the second gate line GL2.

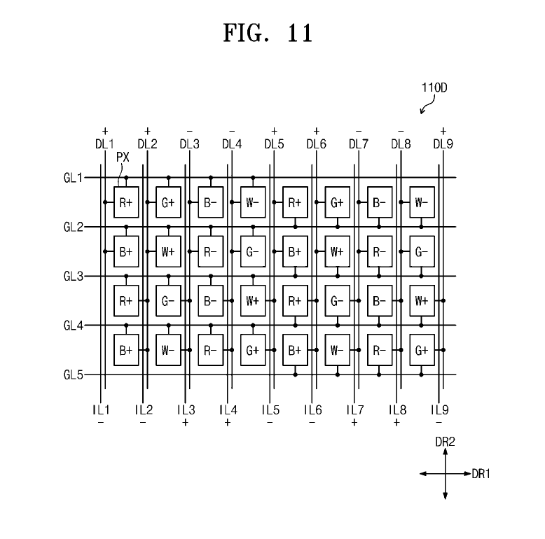

Referring to FIG. 11, connections between the pixels PX and the data lines DL1 to DL9 are substantially the same as those of FIG. 9. Pixels PX in an h-th column disposed between an i-th gate and an i+1-th gate line of the display panel 110D may be alternately connected to the i-th gate line and the i+-1-th gate line in four pixels PX unit.

When the reference symbols i and h are 1, front four pixels PX of the pixels PX in the first row may be connected to the first gate line GL1, and next four pixels PX of the pixels PX in the first row may be connected to the second gate line GL2.

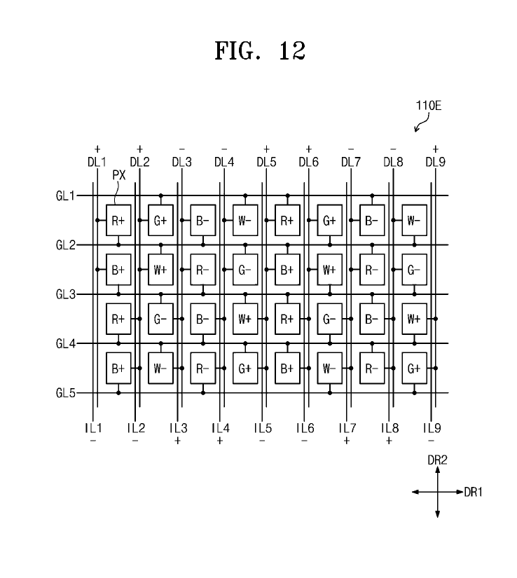

Referring FIG. 12, connections between the pixels PX and the data lines DL1 to DL9 are substantially the same as those of FIG. 9.

The pixels in an h-th row disposed between an i-th gate line and an i+1-th gate line of the display panel 110E may be inverted and connected to the i-th gate line and the i+1-th gate line in a unit of the four pixels. Also, four units pixels PX may be alternately connected to the i-th gate line and the i+1-th gate line in one pixel unit.

When the reference symbols i and h are 1, front four pixels of the pixels in the first row may be successively connected to the second, first, second, and first gate lines GL2, GL1, GL2, and GL1, and the next four pixels of the pixels in the first row may be successively connected to the first, second, first, and second gate lines GL1, GL2, GL1, and GL2.

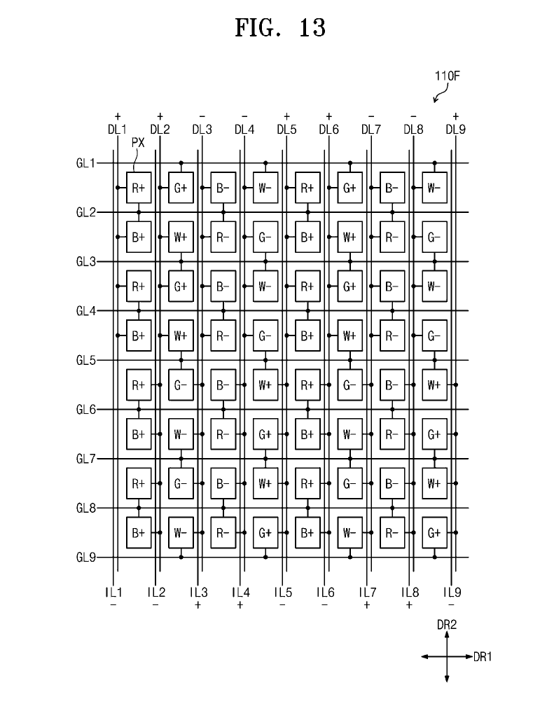

Each of the display panels 110F to 110I of FIGS. 13 to 16 has the same connections as those of each of the display panels 110B to 110E except for the connections between the pixels PX and the data lines DL1 to DL9.

Referring to FIGS. 13 to 16, pixels PX in a c-th column disposed between a j-th data line and a j+1-th data line may be alternately connected to the j-th data line and the j+1-th data line in a unit of the four pixels.

When the reference symbols j and c are 1, the pixels in the first column disposed between the first and second data lines DL1 and DL2 may be alternately connected to the first and second data lines DL1 and DL2 in the unit of the four pixels.

For example, the red pixel R+ in the first row, the blue pixel B+ in the second row, the red pixel R+ in the third row, and the blue pixel B+ in the fourth row of the pixels in the first column may be connected to the first data line DL1. Also, the red pixel R+ in a fifth row, the blue pixel B+ in a sixth row, the red pixel R+ in a seventh row, and the blue pixel B+ in a eighth row of the pixels in the first column may be connected to the second data line DL2.

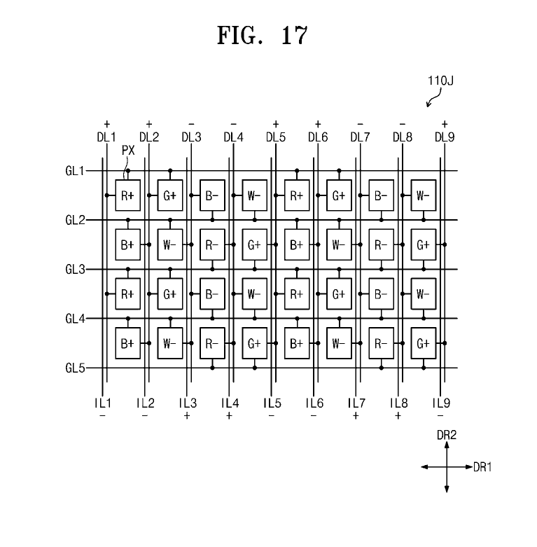

Each of the display panels 110J to 110L of FIGS. 17 to 19 has the same connections as those of each of the display panels 110C to 110E except for the connections between the pixels PX and the data lines DL1 to DL9.

Referring to FIGS. 17 to 19, pixels PX in a c-th column disposed between a j-th data line and a j+1-th data line may be alternately connected to the j-th data line and the j+1-th data line in one pixel unit.

When the reference symbols j and c are 1, the pixels in the first column disposed between the first and second data lines DL1 and DL2 may be alternately connected to the first and second data lines DL1 and DL2 in one pixel unit.

For example, the red pixel R+ in the first row of the pixels in the first column may be connected to the first data line DL1, and the blue pixel B+ in the second row of the pixels in the first column may be connected to the second data line DL2. Also, the red pixel R+ in the third row of the pixels in the first column may be connected to the first data line DL1, and the blue pixel B+ in the fourth row of the pixels in the first column may be connected to the second data line DL2.

In the display panels 110A to 110L of FIGS. 8 to 19, the data voltages applied to the same pixel disposed in the same row may have the same polarity. The inversion voltages may be applied to the inversion lines IL1 to IL9 disposed adjacent to the data lines DL1 to DL9.

The sum of the polarities of the data voltages applied to the data lines DL1 to DL9 and the polarities of the inversion voltages applied to the inversion lines IL1 to IL9 may be offset, and thus the ripple of the common voltage may he prevented. Thus, when the display panels 110A to 110L of FIGS. 8 to 19 are driven, the ripple of the common voltage may be prevented.

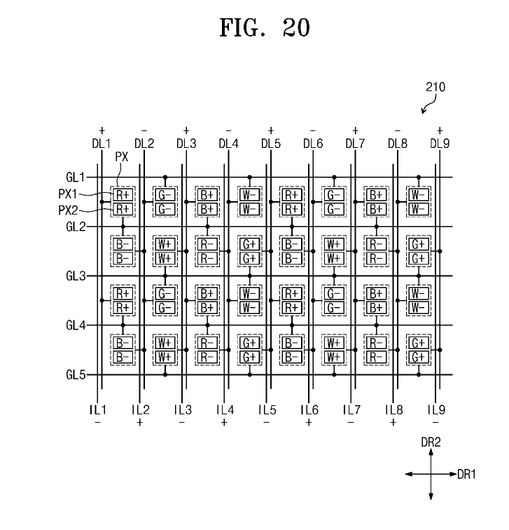

FIG. 20 is a plan view illustrating a portion of the display panel according to an embodiment of the inventive concept.

Referring to FIG. 20, a display panel 210 includes a plurality of pixels PX. Each of the pixels PX includes a first sub pixel PX1 and a second sub pixel PX2 that represent images having gray scales different from each other. The first and second sub pixels PX1 and PX2 are connected to the same gate and data lines.

The first and second pixels PX1 and PX2 may receive the data voltages having the same polarity and charge the pixel voltages having levels different from each other. In this case, user's eyes looking at the display apparatus may recognize a middle value of two pixel voltages.

Thus, deterioration of a side viewing angle, which is generated due to distortion of a gamma curve under an intermediate gray scale, may be prevented. That is, since the first and second sub pixels PX1 and PX2 are charged to have the different pixel voltages, the display apparatus may be improved in visibility.

A structure of the pixel PX including the first and second sub pixels PX1 and PX2 illustrated in FIG. 20 may be defined as a visible structure.

The visible structure illustrated in FIG. 20 is substantially a structure applied to the pixels PX of FIG. 4. However, the present disclosure is not limited thereto, and the visible structure may be applied to the pixels PX of the display panels 110A to 110L of FIGS. 8 to 19.

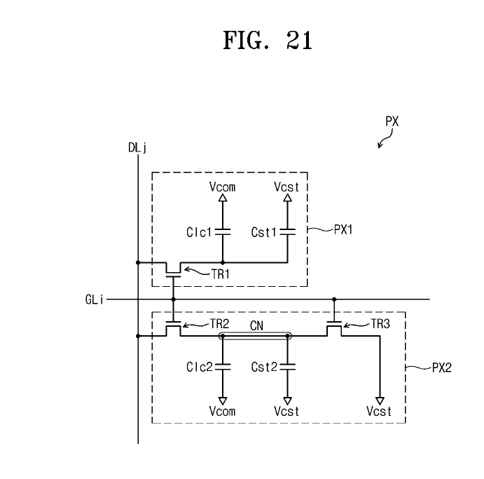

FIG. 21 is an equivalent circuit diagram of one pixel of FIG. 20.

Although the equivalent circuit diagram of one pixel PX is illustrated in FIG. 21, other pixels PX of FIG. 20 may substantially have the same constitutions as that of FIG. 21.

Referring to FIG. 21, the pixel PX includes the first sub pixel PX1 charging a first pixel voltage and the second sub pixel PX2 charging a second pixel voltage having a level different from that of the first pixel voltage. The first sub pixel PX1 includes a first transistor TR1, a first liquid crystal capacitor Clc1, and a first storage capacitor Cst1. The second sub pixel PX2 includes a second transistor TR2, a third transistor TR3, a second liquid crystal capacitor Clc2, and a second storage capacitor Cst2.

The first transistor TR1 includes a gate electrode connected to an i-th gate line GLi, a source electrode connected to a j-th data line DLj, and a drain electrode connected to the first liquid crystal capacitor Clc1 and the first storage capacitor Cst1.

A first electrode of the first liquid crystal capacitor Clc1 is connected to the drain electrode of the first transistor TR1. A second electrode of the first liquid crystal capacitor Clc1 receives a common voltage Vcom. A first electrode of the first storage capacitor Cst1 is connected to the drain electrode of the first transistor TR1. A second electrode of the first storage capacitor Cst1 receives a storage voltage Vest.

The second transistor TR2 includes a gate electrode connected to the i-th gate line GLi, a source electrode connected to the j-th data line DLj, and a drain electrode connected to the second liquid crystal capacitor Clc2 and the second storage capacitor Cst2.

A first electrode of the second liquid crystal capacitor Clc2 is connected to the drain electrode of the second transistor TR2, and a second electrode of the second liquid crystal capacitor Clc2 receives the common voltage Vcom. A first electrode of the second storage capacitor Cst2 is connected to the drain electrode of the second transistor TR2, and a second electrode of the second storage capacitor Cst2 receives the storage voltage Vest.

The third transistor TR3 includes a gate electrode connected to the i-th gate line GLi, a source electrode receiving the storage voltage Vest, and a drain electrode connected to the drain electrode of the second transistor TR2. That is, the drain electrode of the third transistor TR3 is connected to the first electrode of the second liquid crystal capacitor Clc2.

The first to third transistors TR1 to TR3 may be turned on in response to the gate signal received through the i-th gate line GLi. The data voltage received through the j-th data line DLj is provided to the first sub pixel PX1 through the turned-on first transistor TR1. Thus, the first pixel voltage corresponding to a difference between levels of the data voltage and the common voltage Vcom is charged in the first liquid crystal capacitor Clc1.

The data voltage received through the j-th data line DLj is provided to the second sub pixel PX2 through the turned on second transistor TR2. That is, the data voltage received through the j-th data line DLj is provided to the second liquid crystal capacitor Clc2 through the second transistor TR2.

The turned on third transistor TR3 receives the storage voltage Vest to provide the received storage voltage Vest to the second sub pixel PX2. That is, the storage voltage Vest is provided to the second liquid crystal capacitor Clc2 through the third transistor TR3.

The data voltage may have one of the positive and negative polarities. The common voltage Vcom may be substantially the same as the storage voltage Vcst.

A voltage on a contact point node CN at which the drain electrode of the second transistor TR2 is connected to the drain electrode of the third transistor TR3 is a voltage divided by resistance in a resistance state when the second and third transistors TR2 and TR3 are turned on.

That is, the contact point node CN may have the voltage that is less than the data voltage provided through the turned on second transistor TR2 and is greater that the storage voltage Vest provided through the turned on third transistor TR3. The second pixel voltage corresponding to a difference between levels of the voltage of the contact point node CN and the common voltage Vcom.

Since the second pixel voltage is the pixel voltage corresponding to the difference between levels of the voltage of the contact point node CN and the common voltage Vcom, the first pixel voltage charged in the first liquid crystal capacitor Clc1 is greater than the second pixel voltage charged in the second liquid crystal capacitor Clc2. As a result, since the first pixel voltage charged in the first sub pixel PX1 is different from the second pixel voltage charged in the second sub pixel PX2, the display apparatus may be improved in visibility.

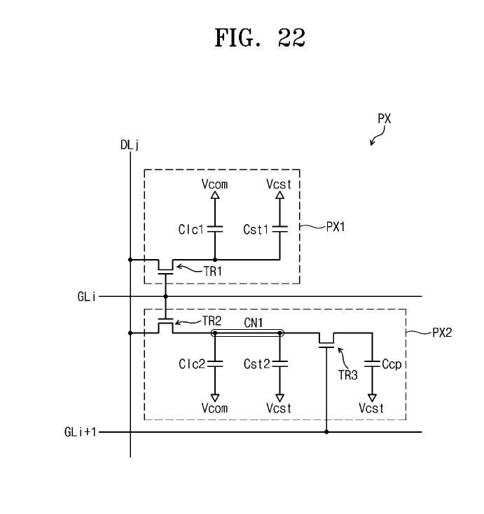

FIG. 22 is another equivalent circuit diagram of one pixel of FIG. 20.

Referring to FIG. 22, the pixel PX1 includes a first sub pixel PX1 and a second sub pixel PX2. The first sub pixel PX1 includes a first transistor TR1, a first liquid crystal capacitor Clc1, and a first storage capacitor Cst1. The second sub pixel PX2 includes a second transistor TR2, a third transistor TR3, a second liquid crystal capacitor Clc2, a second storage capacitor Cst2, and a coupling capacitor Ccp.

The first transistor TR1 includes a gate electrode connected to an gate line GLi, a source electrode connected to a j-th data line DLj, and a drain electrode connected to the first liquid crystal capacitor Clc1 and the first storage capacitor Cst1.

A first electrode of the first liquid crystal capacitor Clc1 is connected to the drain electrode of the first transistor TR1. A second electrode of the first liquid crystal capacitor Clc1 receives a common voltage Vcom. A first electrode of the first storage capacitor Cst1 is connected to the drain electrode of the first transistor TR1. A second electrode of the first storage capacitor Cst1 receives a storage voltage Vest.

The second transistor TR2 includes a gate electrode connected to the i-th gate line GLi, a source electrode connected to the j-th data line DLj, and a drain electrode connected to the second liquid crystal capacitor Clc2 and the second storage capacitor Cst2.

A first electrode of the second liquid crystal capacitor Clc2 is connected to the drain electrode of the second transistor TR2, and a second electrode of the second liquid crystal capacitor Clc2 receives the common voltage Vcom. A first electrode of the second storage capacitor Cst2 is connected to the drain electrode of the second transistor TR2, and a second electrode of the second storage capacitor Cst2 receives the storage voltage Vest.

The third transistor TR3 includes a gate electrode connected to an i+1-th gate line GLi+1, a source electrode connected to the coupling capacitor Ccp, and a drain electrode connected to the drain electrode of the second transistor TR2. A first electrode of the coupling capacitor Ccp is connected to the source electrode of the third transistor TR3, and a second electrode of the coupling capacitor Ccp receives the storage voltage Vest.

Although not shown in FIG. 20, when the structure of the pixel PX of FIG. 22 is applied to the pixel PX of FIG. 20, the third transistor TR3 of the second sub pixel PX2 may be connected to the i+1-th gate line GLi+1.

The first and second transistors TR1 and TR2 may be turned on in response to the gate final received through the i-th gate line GLi. The data voltage received through the j-th data line DLj is provided to the first and second pixels PX1 and PX2 through the turned on first and second transistors TR1 and TR2. Thus, the first pixel voltage corresponding to a difference between levels of the data voltage and the common voltage Vcom may be charged in the first and second liquid crystal capacitors Clc1 and Clc2.

Then, the third transistor TR3 may be turned on in response to the gate signal received through the i+1-th gate line GLi+1. The voltage may be divided between second liquid crystal capacitor Clc2 and the coupling capacitor Ccp by the third transistor TR3.

A voltage of a contact point node CN1 at which the drain electrode of the second transistor TR2 is connected to the drain electrode of the third transistor TR3 is a voltage that is divided according to charge sharing in which electric charges stored in the second liquid crystal capacitor Clc2, the second storage capacitor Cst2, and the coupling capacitor Ccp are shared. That is, after the gate signal is applied through the i+1-th gate line GLi+1, the voltage charged in the second liquid crystal capacitor Clc2 decreases.

Thus,the first pixel voltage charged in the first liquid crystal capacitor Clc1 is greater than the second pixel voltage charged in the second liquid crystal capacitor Clc2. As a result, since the first pixel voltage charged in the first sub pixel PX1 is different from the second pixel voltage charged in the second sub pixel PX2, the display apparatus may be improved in visibility.

The display apparatus of the inventive concept may prevent the ripple of the common voltage to improve the display quality.

Although the exemplary embodiments have been described herein, it is understood that the disclosure is not intended to be limited to these exemplar embodiments and various changes and modifications can be made by one of ordinary skilled in the art in light of the above teachings and within the spirit and scope of the present disclosure.

What is claimed is:

1. A display apparatus comprising:
a plurality of gate lines configured to receive gate signals and extending in a first direction;
a plurality of data lines configured to receive data voltages and extending in a second direction that intersects the first direction;
a plurality of pixels connected to the gate lines and data lines; and
a plurality of inversion lines configured to receive inversion voltages having polarities opposite to those of the data voltages and extending in the second direction.

2. The display apparatus of claim 1, wherein each of the inversion lines is disposed adjacent to a corresponding data line of the data lines.

3. The display apparatus of claim 1, further comprising:
a gate driving unit for applying the gate signals to the gate lines; and
a data driving unit for applying the data voltages to the data lines.

4. The display apparatus of claim 1, further comprising an inversion driving unit for receiving the data voltages from the data lines and inverting the polarities of the data voltages to output the inverted voltages.

5. The display apparatus of claim 4, wherein the inversion driving unit is disposed to face the data driving unit with a display panel therebetween.

6. The display apparatus of claim 4, wherein the inversion driving unit comprises a plurality of inversion units disposed to correspond to the inversion lines to invert the polarities of the data voltages, thereby outputting the inverted voltages.

7. The display apparatus of claim 6, wherein each of the data lines has one end connected to the data driving unit, and
each of the inversion units has an input terminal connected to the other end of a corresponding data line of the data lines, and
each of the inversion units has an output terminal connected to a corresponding inversion line of the inversion lines.

8. The display apparatus of claim 4, wherein the inversion driving unit is disposed between the display panel and the data driving unit.

9. The display apparatus of claim 8, wherein the inversion driving unit comprises a plurality of inversion units configured to invert the polarities of the data voltages to output the inverted voltages, and
each of the data lines has one end connected to the data driving unit, and
each of the inversion units has an input terminal connected to the other end of a corresponding data line of the data lines, and
each of the inversion units has an output terminal connected to a corresponding inversion line of the inversion lines.

10. The display apparatus of claim 1, further comprising:
a gate driving unit configured to generate the gate signals; and
a data driving unit configured to generate the data voltages to invert polarities of the data voltages, thereby outputting the inverted voltages.

11. The display apparatus of claim 10, wherein the data driving unit comprises an version driving unit for generating the inversion voltages.

12. The display apparatus of claim 1, wherein each of the pixels represents any one of red, green, blue, white, yellow, cyan, and magenta colors.

13. The display apparatus of claim 1,wherein the pixels are grouped into first and second pixel groups, and
the first and second pixel groups are alternately disposed in the first and second directions.

14. The display apparatus of claim 13, wherein the first and second pixel groups in a h-th (where h is a natural number) row and the first and second pixel groups in an h+1-th row are configured to receive data voltages having polarities different from each other.

15. The display apparatus of claim 13, wherein each of the first and second pixel groups comprises 2k (where k is a natural number) pixels.

16. The display apparatus of claim 13, wherein each of the first pixel groups comprises two of red, green, blue, and white pixels, and
each of the second pixel groups comprises the other two of the red, green, blue, and white pixels.

17. A display apparatus comprising:
a plurality of pixels connected to gate lines and data lines extending to cross each other;
a plurality of inversion lines extending in parallel to the data lines and each of which is disposed adjacent to a corresponding data line of the data lines;
a gate driving unit for applying gate signals to the gate lines;
a data driving unit for applying data voltages to the data lines; and
an inversion driving unit configured to receive the data voltages from the data lines to invert polarities of the data voltages, thereby configured to apply the inverted voltages to the inversion lines.

18. The display apparatus of claim 17, wherein the inversion driving unit is disposed to face the data driving unit with a display panel herebetween.

19. The display apparatus of claim 17, wherein the inversion driving unit comprises a plurality of inversion units disposed to correspond to the inversion lines to invert the polarities of the data voltages, thereby outputting the inverted voltages.

20. The display apparatus of claim 19, wherein each of the data lines has one end connected to the data driving unit, and
each of the inversion units has an input terminal connected to the other end of a corresponding data line of the data lines, and
each of the inversion units has an output terminal connected to a corresponding inversion line of the inversion lines.
